(19) United States
(12) Patent Application Publication
(10) Pub. No.: US 2011/0055802 A1
(43) Pub. Date: Mar. 3, 2011

(54) INDUSTRY STANDARDS MODELING SYSTEMS AND METHODS

(76) Inventors: Catherine D. von Unwerth, Midlothian, VA (US); Nathan J. Taylor, Boise, ID (US)

(21) Appl. No.: 12/640,433

(22) Filed: Dec. 17, 2009

Related U.S. Application Data
(60) Provisional application No. 61/232,950, filed on Sep. 3, 2009.

(51) Int. Cl. G06F 9/44

(52) U.S. Cl. 717/104

(57) ABSTRACT

A method of developing a repeatable state-specific Medicaid management information system model includes creating a single Medicaid IT Architecture (MITA) Framework model around a Medicaid IT Architecture standard; creating a single Medicaid management information system model from the MITA Framework model; and creating at least one state-specific Medicaid management information system model from the Medicaid management information system model. The step of creating at least one customer-specific model is repeatable to create additional, different customer-specific software models.

### RELATED APPLICATIONS

The present application claims the benefit, under 35 U.S.C. §119(e), of U.S. Provisional Patent Application 61/232,950, filed Aug. 11, 2009 and titled “INDUSTRY STANDARDS MODELING SYSTEM,” the disclosure of which is hereby incorporated by reference herein in its entirety. The present application is related to copending application Ser. Nos. 12/640,380 (VA015-A), 12/640,410 (VA015B) and Attorney Docket Number: VA015D, filed concurrently herewith and titled “INDUSTRY STANDARDS MODELING SYSTEMS AND METHODS,” the disclosures of which are hereby incorporated by reference herein in their entirety.

### TECHNICAL FIELD

The present disclosure relates to modeling systems and methods, and more particularly to an industry standard modeling system and method for ensuring compliance with industry requirements.

### BACKGROUND

Many businesses and government entities use software to streamline and perform different tasks. Traditionally, the software employed is customized and may be custom-built. Over time, modifications are made to the software to adapt it to changing business needs. Customized software is labor-intensive and thus expensive. Customized software is typically poorly documented, thus making it difficult to maintain and modify for further enhancements.

Older business software and associated hardware are often referred to as “legacy” systems. A legacy system is an existing system within a company that continues to be used despite being out-of-date, incompatible with current systems, or otherwise undesirable. Generally, legacy systems tend to be difficult and expensive to modify or replace. Legacy systems typically continue to be used despite such shortcomings because the cost of replacing or redesigning the system is seen as being cost prohibitive.

One example of such legacy systems are those used by state governments for Medicaid management. Many states and businesses have legacy systems in use for Medicaid management, and these states are typically at a disadvantage when these systems must be adapted to comply with newer Medicaid standards and requirements. Therefore, improvements are desirable.

### SUMMARY

In accordance with the following disclosure, the above and other problems are solved by the following:

In a first aspect, a method of developing a repeatable state-specific Medicaid management information system model is disclosed. The method includes creating a single MITA Framework model around the Medicaid IT Architecture; creating a single Medicaid management information system model from the MITA Framework model; and creating at least one state-specific Medicaid management information system model from the Medicaid management information system model. The step of creating a state-specific model is repeatable to create additional, different state-specific models.

In a second aspect a method of developing a repeatable customer-specific software solution model is disclosed. The method includes creating a single industry standard model around an industry standard; the industry module including an MITA Framework model with a blueprint that has descriptions of at least one business process that is typical to MITA; a software module for creating a single industry software solution model from the industry standard model; and a specific module for creating at least one customer-specific software solution model from the industry software solution model.

In a third aspect a computer program product having a computer readable medium having computer program logic recorded thereon for developing a repeatable state-specific Medicaid management information system model is disclosed. The computer program product includes code for creating a single Medicaid IT Architecture (MITA) Framework model around a Medicaid IT Architecture standard; code for creating a single Medicaid management information system model from the MITA Framework model; and code for creating at least one state-specific Medicaid management information system model from the Medicaid management information system model. The step of creating a state-specific model is repeatable to create additional, different state-specific models.

### BRIEF DESCRIPTION OF THE DRAWINGS

FIG. 1 illustrates a MITA Framework, according to principals of the present disclosure;

FIG. 2 is a block diagram illustrating an overview of a system for creating a software solution for an organization, according to principals of the present disclosure;

FIG. 3 is a block diagram illustrating a modeling system, according to principals of the present disclosure;

FIG. 4 is a block diagram illustrating a modeling system, according to principals of the present disclosure;

FIG. 5 is a block diagram illustrating components of a modeling system, according to principals of the present disclosure;

FIG. 6 illustrates modules of a MITA Framework blueprint, according to principals of the present disclosure;

FIG. 7 illustrates modules of a MITA Framework blueprint, according to principals of the present disclosure;

FIG. 8 illustrates modules of a software solution blueprint, according to principals of the present disclosure;

FIG. 9 illustrates a dataflow, according to principals of the present disclosure; and

FIG. 10 is an illustration of an exemplary system, adapted according to principles of the present disclosure, for implementing the solutions and processes described below.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein may be implemented as a sequence of computer implemented steps, operations, or procedures running on a programmable circuit within a computer, a sequence of computer implemented steps, operations, or procedures running on a programmable circuit within a directory system, database, or compiler, or combinations thereof.

Recently, the Center for Medicaid and State Operations (CMS) introduced a Medicaid IT Architecture (MITA) Framework 2.01. CMS is a United States Federal Agency that administers Medicare, Medicaid, and the Children's Health Insurance Program. Under the Medicaid system, each state administers its own Medicaid program while the federal Centers for Medicare and Medicaid Services

CMS monitors the state-run programs to ensure that established minimum requirements for service delivery, quality, funding, and eligibility standards are met.

The purpose of MITA is to establish national guidelines for technologies and processes that can enable improved program administration for Medicaid enterprises. A Medicaid enterprise is made up of entities that have an interest in seeing that the mission and goals of the Medicaid program are met. MITA is intended to foster national integrated business and IT transformation. MITA sets forth established national guidelines for technologies and business processes to enable improved program administration for State Medicaid enterprises. State Medicaid enterprises share common goals and objectives for the outcomes of the Medicaid program. The MITA Framework defines processes and planning guidelines for enabling state Medicaid enterprises to meet common objectives within the MITA Framework, while supporting local needs.

The MITA Framework is a consolidation of principles, models, and guidelines that combine to form a template for the states to use to develop their own enterprise architectures. The MITA processes provide guidance for State Medicaid enterprises to use in adopting the MITA Framework through shared leadership, partnering, and reuse of solutions. MITA planning guidelines help states define their own strategic MITA goals and objectives and develop tailored enterprise architectures that are fully consistent with CMS requirements.

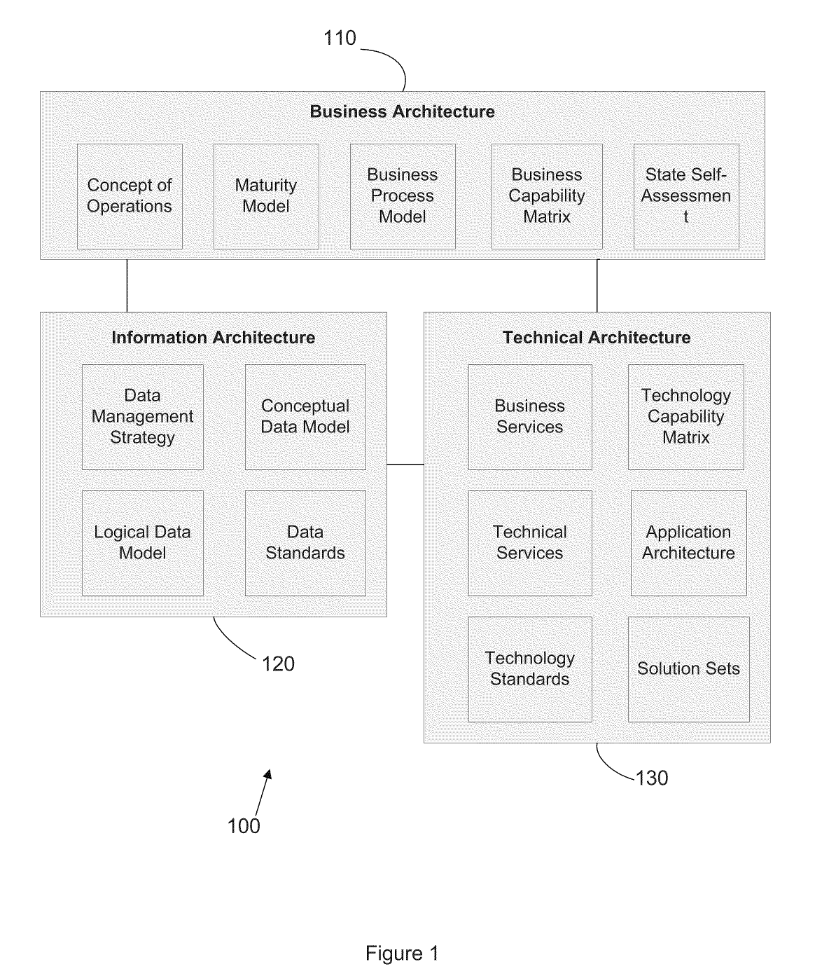

The MITA Framework is a blueprint that states can use to examine their business priorities, plan future improvements, and acquire technical applications that meet both their needs and the objectives of the MITA initiative. Referring to FIG. 1, the MITA Framework 100 describes a logical architecture for the Medicaid enterprise. The MITA Framework 100 includes a business architecture module 110, an information architecture module 120, and a technical architecture module 130. The business architecture 110 has five components including concept of operations, maturity model, business process model, business capability matrix, and state self-assessment. The information architecture 120 has four components and includes data management strategy, logical data model, conceptual data model, and data standards. The technical architecture 130 has six components and includes business services, technical services, technology standards, technology capability matrix, application architecture, and solution sets.

The MITA Framework is a consolidation of principles (e.g., interoperability, data sharing, and reusability), models (e.g., the MITA Maturity Model, Business Process Model, and various Technology Models), and national guidelines, such as those promoted by the Office of the National Coordinator for Health IT, the Federal Enterprise Architecture, and Federal Health Architecture. States can use the MITA Framework to develop their own enterprise architectures. The MITA Framework includes eight high-level business processes. These include business relationship management, care management, contractor management, member management, operations management, program management, program integrity management, and provider management.

The MITA Framework also draws from several industry-accepted models, including the Zachman Framework, the Federal Enterprise Architecture Framework Reference Models, the National Association of State Chief Information Officers Architecture Handbook, and other contemporary methodologies. The MITA team adapted industry methodologies and models to meet the unique requirements of State Medicaid programs across the country. The result of this effort is a series of architectures, models, and supporting processes optimized for the multistate Medicaid community.

MITA has the following goals: develop seamless and integrated systems that effectively communicate; achieve common Medicaid goals through interoperability and shared standards; promote an environment that supports flexibility, adaptability, and rapid response to changes in programs and technology; promote an enterprise view that supports enabling technologies aligned with Medicaid business processes and technologies; provide data that is timely, accurate, usable, and easily accessible to support analysis and decision making for healthcare management and program administration; provide performance measurement for accountability and planning; and coordinate with public health and other partners to integrate health outcomes within the Medicaid community.

Health Level Seven (HL7) is an all-volunteer, not-for-profit organization involved in development of international healthcare standards. “HL7” is also used to refer to some of the specific standards created by the organization. HL7 and its members provide a framework and related standards for the exchange, integration, sharing, and retrieval of electronic health information. Version 2 of the standards, which support clinical practice and the management, delivery, and evaluation of health services, are the most commonly used health information standards in the world.

In general, the present disclosure relates to a solution that has a business centric organization and processes that can support three general areas: an industry standard, a software solution, and the customer. In one example embodiment, this solution uses the MITA Framework as a common ground where the customer can bring their state-specific knowledge and requirements and apply them to the MITA Framework. Then, a Medicaid Management Information System (MMIS) solution can be applied to the MITA Framework. In essence, the MITA Framework acts as a bridge between the MMIS solution and the state specific knowledge and requirements.

First, the MITA Framework is modeled to create an industry standard model using modeling tools and techniques. Then, a second separate set of models is created applying a MMIS solution. Finally, a set of state-specific models can be created. The state-specific models can be repeated for additional customers.

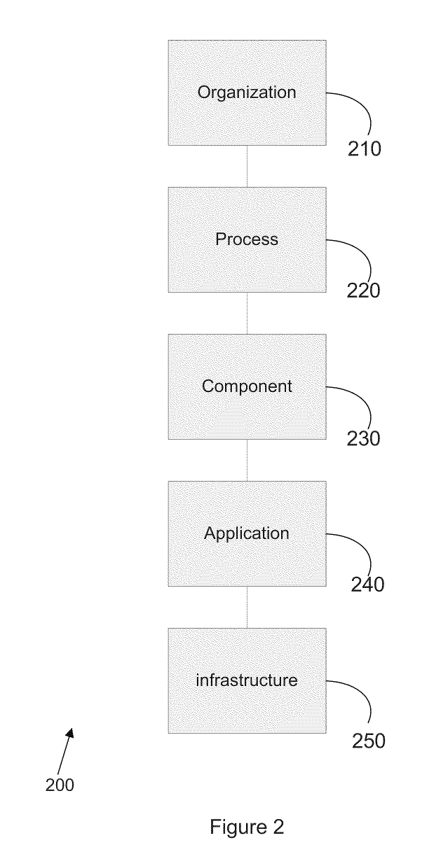

FIG. 2 is a functional diagram showing an overview of an enterprise 200, and the various levels at which the enterprise 200 can be modeled. By the term “enterprise” it is meant any business, organization, entity, etc. that performs in any line of business, management, or government. The complexity of the business process or processes to be automated may range from very simple to highly complex. While a more complex enterprise may require a more complex software solution, the structure of the enterprise 200 is typically still similar.

The enterprise 200 can be modeled or defined by a series of levels 210, 220, 230, 240, and 250. At the organization level 210, the organization of the enterprise 200 is defined. The organization represents such features as how the organization is divided into departments, how the management of the organization is structured, and the like. Such a definition can be created in any number of ways, such as by interviewing company personnel, reviewing company organizational references and the like. As may be appreciated, an enterprise, and events that take place within the enterprise, may also be defined in any number of ways. For example, an enterprise may be defined in terms of each employee's job function or in terms of each employee's relationship to other employees. For example, the organization may reflect that an airline has a luggage department and a ticketing department, and that the heads of those departments both report to a chief of operations.

Another level at which an enterprise may be modeled is the process level 220. The process level 220 represents the various processes that the organizations in level 110 carry out. It is noted that level 110 and level 120 convey different types of information. That is, an organization can be described without reference to what it does, and processes can be described without reference to who will perform them. However, there may be a mapping between levels. For example, certain organizations may participate in certain processes but not in others.

In some embodiments, the company organization determined in level 210 can be mapped into a process definition. An exemplary process definition may be a process used by an airline to receive a reservation over the Internet. Another type of process may be a process of receiving luggage at a check in counter and transporting it to the appropriate plane. An entire company may be viewed in terms of the processes that take place therein. Some of the processes, such as the receipt of a reservation over the Internet, may benefit from a high degree of automation by business software. Other processes, such as moving luggage from the check-in counter to the airplane, cannot easily be automated by business software. Still, other processes may be capable of being automated, but for business or economic reasons the company may desire to continue performing such processes manually.

A component level 230 represents the various components that will ultimately be used to build a software solution for the enterprise 200. The processes selected for automation are mapped into software components at the component level 230. Software components may be reused for similar processes and therefore need not be created every time a business software solution is desired. Therefore, a library of business software-specific components may be maintained, and an appropriate component may be selected when needed. If a software component is not available for a particular process, then an appropriate component may be created.

An application level 240 represents the applications into which components may be incorporated. Software applications may be available already in a library or may be created. Any combination of pre-fabricated and specially-made components and applications embody a software solution. The software solution is enabled by way of a computer infrastructure 250. The computer infrastructure 250 may comprise any type of computing equipment, including combinations thereof, that is capable of implementing the software solution.

The business processes described above can be defined by a blueprint. A blueprint is a collection of information, called artifacts, that can be used to create a cross-referenced representation of the business processes that occur within the enterprise 200. For example, an artifact may take the form of a word processing document, a spreadsheet, database, organizational chart, and the like. Typically, several artifacts are cross-referenced so the interrelationships between business processes and can be accounted for.

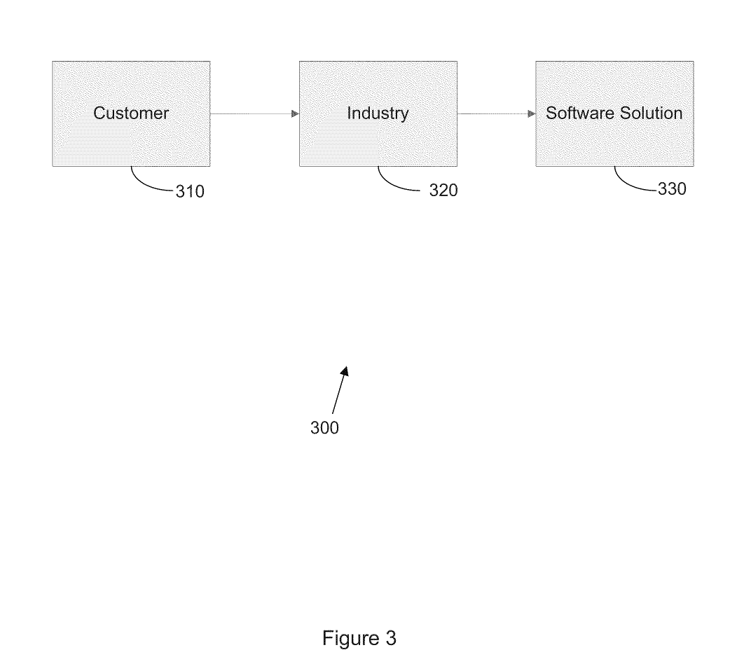

Referring now to FIG. 3, a modeling system 300, according to one example embodiment, includes a customer module 310, an industry module 320, and a software solution module 330. The customer module 310 can include a state's policies and processes related to a Medicaid program. The industry module 320 can include the MITA Framework. The software solution module 330 provides a software solution, such as an MMIS. In one embodiment, a blueprint is preconfigured for the industry model 320. For example, a blueprint can be created for the MITA Framework. The artifacts within the blueprint can be preconfigured with descriptions of processes that are typical to MITA. For example, HL7 publishes documents defining the business processes for MITA. The HL7 documents can be conformed into artifacts that can be entered into the blueprint for the MITA Framework. Once the artifacts within the blueprint are completed, the business processes will be well defined and a software solution can be generated.

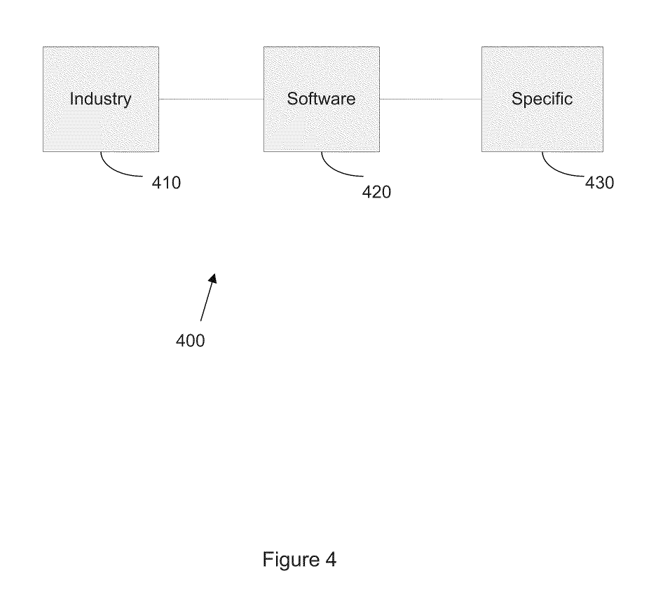

Referring now to FIG. 4, a modeling system 400, according to one example embodiment, includes an industry module 410, a software module 420, and specific module 430. The industry module 410 is an industry standard model, or blueprint, and includes the MITA Framework model. In some embodiments, the industry model 410 can include all the artifacts associated with the MITA Framework, including the HL7 documents. In the illustrated embodiment, industry module 410 ties the business architecture 110, information architecture 120, and technical architecture 130 into one model.

The software module 420 includes an MMIS model, or blueprint. The software module 420 addresses the industry model 410 and may automate many of the business processes therein. The specific module 430 includes state-specific models, or blueprints. Thus, the software module 420 can be custom tailored to address the state-specific requirements in the specific module 430. By developing and maintaining a single modeling system 400 to develop MMIS models and state-specific models, consistent and repeatable processes, products and services can be delivered.

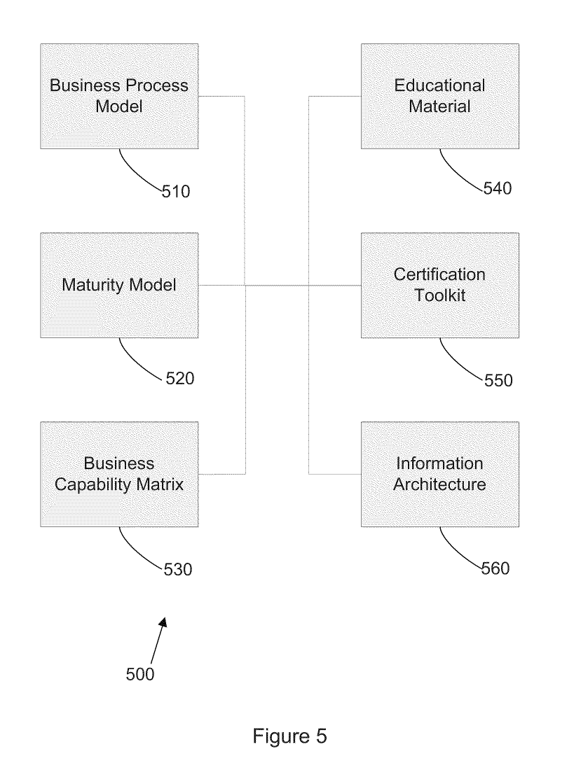

Referring to FIG. 5, some embodiments of a modeling system 500 may include a business process model module 510, a maturity model module 520, a business capability matrix module 530, an educational material module 540, a certification toolkit module 550, and an information architecture module 560. The business process model 510 includes the business processes. By way of example, a MITA business process blueprint 410 can be developed from the HL7 business processes. The MITA blueprint can then be used to develop a MMIS blueprint 420. The MMIS blueprint can then be used to develop a state-specific blueprint 430. The MITA blueprint can be updated and maintained as industry standards are modified and refined. Those changes can also be flowed through to the MMIS blueprint 420 and the state-specific blueprint 430. As can be appreciated, a particular state may employ one or more business processes that are unique, and therefore the MMIS blueprint 420 and the MITA Framework blueprint 410 may not completely describe all of the relevant business processes of the company. Thus, artifacts may need to be modified, destroyed, and even created if necessary. In addition, any cross-references between the artifacts may need to be changed if the interrelationships between processes require it.

The use of a blueprint supports end-to-end traceability, Return on Investment analysis, and Model Driven Architecture capabilities. These goals may be achieved through the use of various software development tools, such as RATIONAL ROSE and REQUISITE PRO. Such software tools are generally well known in the art and thus are not described herein.

State-specific blueprints could be developed using the MITA blueprint as a base. The state could develop “as-is” business processes as well as “to-be” business processes. The “as-is” business processes can be used to create the “to-be” business processes from the blueprint. In some embodiments, the blueprints can also live on and be used to document future changes or enhancements. By using a consistent methodology and a repeatable process like blueprinting, similarities and differences can be seen between two different state's MMIS, providing a tool for developing a single best practice business process.

The maturity model 520 is a reference model and may be used in conjunction with the State Medicaid Mission and Goals and the Business Model. The maturity model 520 may be updated and maintained as the industry standards are modified and refined.

The business capability matrix 530 is used to record a state's capability for a specific MITA business process. The state's capability is based upon the maturity model 520. One state's capability could be compared to another state's to develop best practices. A state can use the modeling system 500 to develop their “Self-Assessment.” The Self-Assessment is a review of the state's own mission and goals and the “as-is” business capabilities against the business capability matrix 530. Using the business process model 510, states could also define Request For Proposal requirements and associate them to the business processes. These RFP requirements could be captured and used as a basis for requesting funds from CMS or other entities.

The first step in the procurement process would be to load the customer RFP requirements. If the RFP was not written around the MITA business process the next step would be to map the customer's RFP requirements to the MITA business process. The MMIS documentation can be used to explain how the customer's requirements are met. This also provides the ability to more quickly identify gaps between the customer requirements and the MMIS solution.

In some embodiments, modeling system 500 may also include educational materials 540. Education materials 540 allow users to better understand the overall role of the MITA blueprint and its use in developing an MMIS implementation. Educational materials 540 can also describe how to use the MITA blueprint, the interrelationship of the various components, and how to maintain any customer-specific blueprints that are created therefrom.

The ultimate goal of an MMIS implementation is to gain CMS certification shortly after the system has gone live. As a part of the certification process, CMS has developed a certification toolkit 550 that contains the protocols and checklists for certification. In some embodiments, these checklists can be imported into modeling system 500. The checklists generally align closely with the MITA business process model 510 and are included as test cases to be executed as a final step of Integration Testing. These checklists can be kept current and updated as CMS changes the certification process.

Using the MITA Business Process Model, a standard MMIS business process model 560 can be developed. This model would apply the technology touch points of where these business processes are performed across the different components of the MMIS solution.

One purpose of performing requirements sessions is to get a complete understanding of the customer's requirements. During the requirements sessions, the customer is trying to understand the capabilities of their new system; meanwhile, the vendor is trying to understand what the customer's processes and policies are to be able to describe how the solution would perform that function. This can be very challenging as the customer's point of reference in many cases is from their current system and business processes, and the vendor's perspective is from their own solution.

One resolution is to structure and facilitate requirements sessions using the MITA business process model 510. This approach can first provide a common understanding of the requirements session topic and scope. Many times end users cannot decompose their specific business processes into specific functions. Using the MITA business process 510 may help focus the conversation and provide the customer a better understanding of how they will perform their tasks in the new MMIS solution. State resources would be better utilized as the scope of the sessions would be clearly defined. By using the MITA blueprints as a road map, the customer will quickly see how the MMIS will support their business needs. These pre-defined solutions can also help limit scope creep and can help focus the conversation on the information needed to complete the configuration of the business process.

During the requirements sessions, more specific and detailed requirements that are associated with the RFP requirements are collected. These solution requirements could be captured directly into the blueprint during the sessions to establish clarity and consensus of the definition of the requirement. The solution requirement can be specific to a particular technical component such as QNXT or Flexi.

An application inventory is a listing of the technical pieces of the MMIS solution. This inventory is used to develop the technology touch points in the business processes. Each application would have a list of features it provides. There may be high level features that are comprised of one or more lower level features or logical feature groups. The feature lists can thus be defined to comprise the feature breakdown structure for each application. These features are mapped to the RFP requirements and provide traceability. Features are used to demonstrate where a proposed software solution has the functionality required by the customer. Examples of features include interfaces, reports, and letters. A list of the interfaces with their data elements are tied to the logical data model as well as a conceptual data model. The interfaces would also trace to the business process. A list of the reports with their data elements are tied to the logical data model as well as the conceptual data model. The letters also trace to the business processes.

The systems and methods described herein will likely be implemented in connection with states that request a software solution for the business processes associated with MITA. Changing market conditions, law changes, improvements to process efficiency, MITA changes, and the like may all necessitate changes to the state's software solution and/or the state specific blueprint. The systems and methods described herein may be documented via the blueprinting to enable the propagation of changes that may be made. For example, a state may change a parameter of a particular state specific business process that is automated by the software solution. Thus, the software is modified to effectuate the change. However, the change may affect other processes within the state, whether automated or not. The completed artifacts that were used to create the now-changed solution provide the tools to determine where additional changes, if any, need to be made to the rest of the blueprint, software solution, or artifacts. This facilitates “traceability” within the software solution, allowing any decisions that are made, including departures from the original blueprint, to be properly documented so that any changes, decisions, or the like, and any effects that such decisions, changes, etc., may have on other parts, are known.

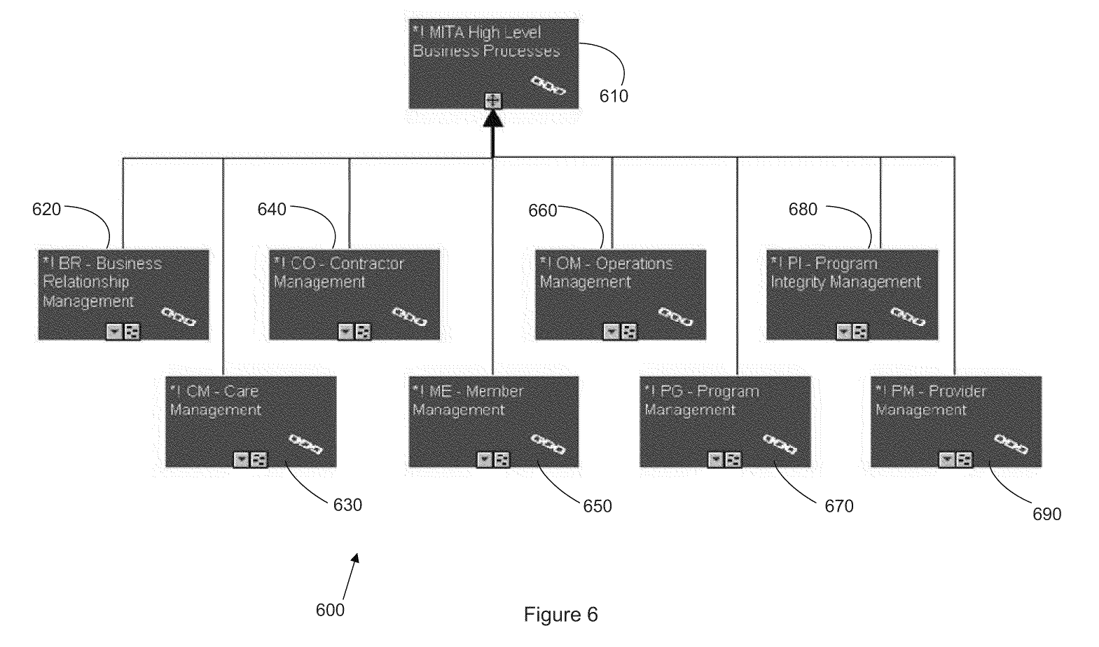

FIG. 6 is a screen shot illustrating an example embodiment of a MITA Framework model 600, according to the principles of the present disclosure. The model 610 includes a MITA high-level business process module 610. Preferably, the high-level business process module 610 includes a business relationship management module 620, a care management module 630, a contractor management module 640, a member management module 650, an operations management module 660, a program management module 670, a program integrity management module 680, and a provider management module 690.

The screen shot of FIG. 6 shows part of a user interface for an application creation tool. In other words, the screen shot of FIG. 6 in this example can be used by one or more programmers who create customer-specific software solutions. For example, in one embodiment, the MITA Framework model 600 is part of an interactive application creation tool, where one or more blueprint modelers access the model 600 to update the model 600, create and/or change MMIS models and blueprints, create and/or change customer-specific models and blueprints, and create and/or change customer-specific software solution packages. The individual modules 610, 620, 630, 640, 650, 660, 670, 680, and 690 are selectable items and are arranged according to the business processes to which each respective module is associated. A blueprint modeler using the application creation tool can access models, blueprints, and software components for automating a business process through the modules 610, 620, 630, 640, 650, 660, 670, 680, and 690.

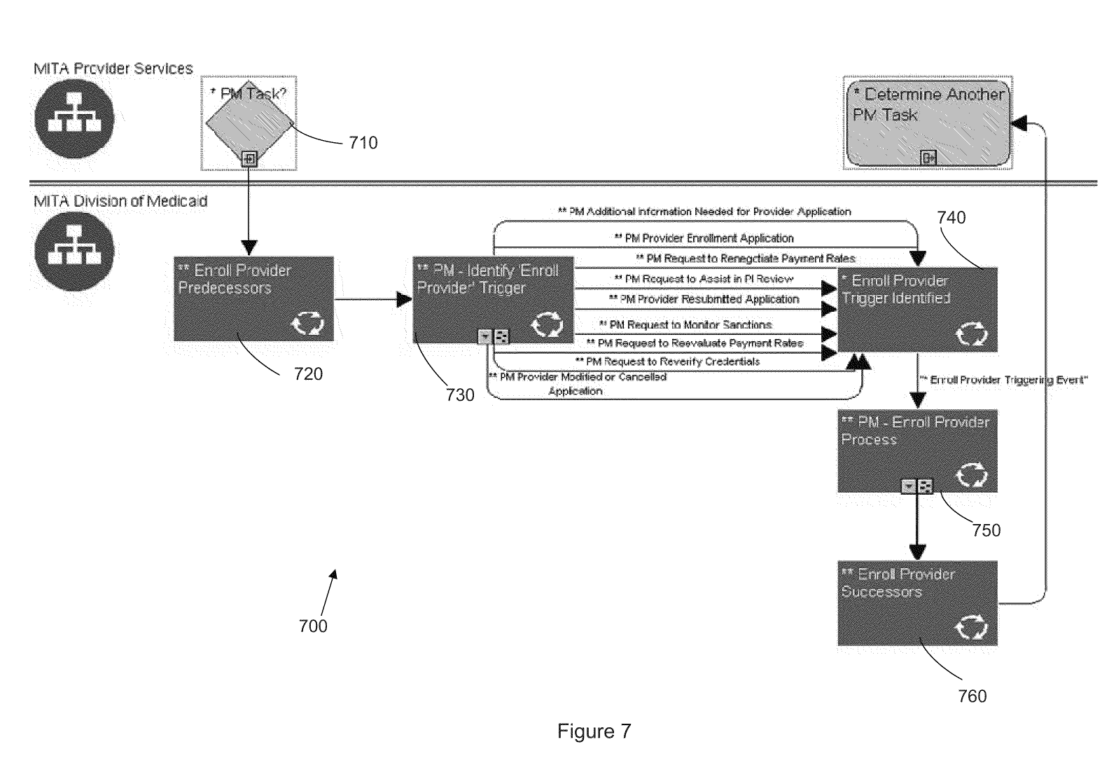

FIG. 7 is a screen shot illustrating an example embodiment of a provider management (“PM”) module 700 of the MITA Framework model 600, according to the principles of the present disclosure. Specifically, the screen shot of FIG. 7 shows at least one aspect of provider management that can be accessed through the module 690 of FIG. 6. In this example, the aspect includes a provider enrollment blueprint that gives an outline of business processes associated with provider enrollment.

A PM Task module 710 determines if there is a PM task to perform. If the PM Task module 710 determines there is a PM task to perform, logical flow proceeds to a first enroll module 720. The first enroll module 720 enrolls the provider predecessors. A Receive Inbound Transaction module (not shown) authenticates the submitter, verifies the application form, translates, scans, logs in request, and produces the enrollment application message which is sent to the enroll provider process module 750. A manage provider communication module (not shown) may send inquiries about the enrollment process or prompt to re-verify the provider. A monitor performance module (not shown) and a business activity module (not shown) may send prompts to reevaluate the provider enrollment. A program integrity module (not shown) may request enrollment review activities.

A module 730 identifies an “enroll provider” trigger. A second enroll module 740 performs data editing functions. A third enroll module 750 controls the enroll process. A successor module 760 is used to enter provider successors. The successor module 760 may manage provider communication, monitor performance and business activity, manage provider information process, send outbound transaction process, or receive inbound transaction process.

While the example of FIG. 7 is provided with respect to enrolling providers, it should be noted that the scope of embodiments is not so limited. The provider management module 690 (FIG. 6) may provide access to a variety of other provider management processes (e.g., deleting a provider), and each of the other modules 610, 620, 630, 640, 650, 660, 670, 680, and 690 of FIG. 6 may provide access to a variety of other respective processes. It is a feature of some embodiments to provide access to selectable software modules for implementing the processes through the interfaces shown in FIGS. 6 and 7. In creating a customer-specific software solution, a blueprint modeler may select a variety of different software components for inclusion in the software solution.

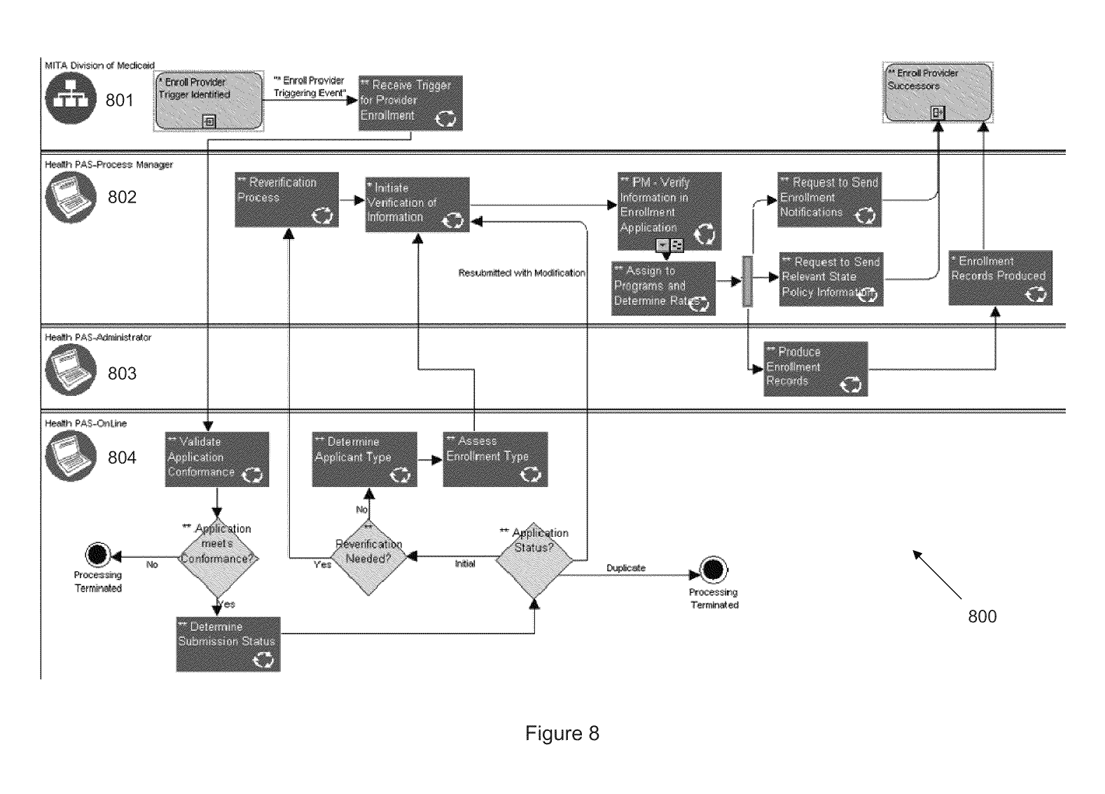

FIG. 8 is a screen shot illustrating an example embodiment of an MMIS software solution 800, according to the principles of the present disclosure. FIG. 8 shows how a single function, provider enrollment, is performed by the software solution 800 across a variety of levels.

The particular architecture of the software solution 800 includes the implementation of various parts of the software solution 800 at a Division of Medicaid entity level 801. The Division of Medicaid entity may be, for example, a state entity that is responsible for administering Medicaid for the state.

Various parts of the software solution 800 are also run at a process manager level 802. In this particular example, some tasks in the provider enrollment business process are delegated to the process manager level 802. Other tasks are delegated to the administrator level 803 and the online level 804. Though the software solution 800 is implemented across the levels 801-804, the software solution 800 provides for an integrated platform for accomplishing various tasks, such as provider enrollment. The provider enrollment function is exemplary, as it is understood that any business process that is capable of computer implementation or automation may be included in the software solution 800.

As shown in FIG. 8, the software solution 800 is run at levels 801-804. In some embodiments, each of the levels may have its own computer infrastructure (e.g., a server and/or a workstation), though in other embodiments, two or more of the levels 801-804 may share computing infrastructure resources. Thus, while the software solution 800 of FIG. 8 is run on one or more computing devices, the scope of embodiments is not limited to any particular hardware architecture.

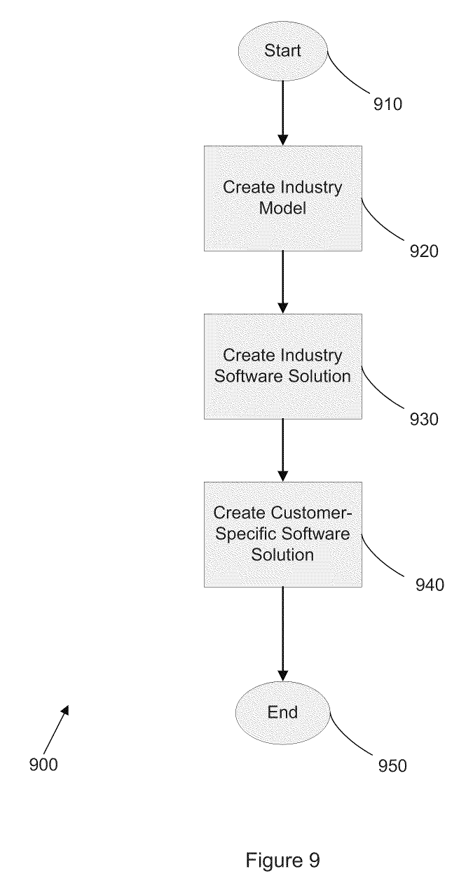

FIG. 9 is a dataflow for developing a repeatable customer-specific software solution model 900, according to the principals of the present disclosure. The logical flow starts at 910. A first create module 920 creates a single industry standard model from an industry standard. For example, the first create module 920 creates a single MITA Framework model from the Medicaid IT Architecture. A second create module 930 creates a single industry software solution model from the industry standard model. For example, the second create module 930 creates a single Medicaid management information system model from the MITA Framework model created by the first create module 920. A third create module 940 creates at least one customer-specific software solution model from the industry software solution model. For example, the third create module 940 creates at least one state-specific Medicaid management information system model from the Medicaid management information system model created by the second create module 930. Logical flow ends at 950.

While the logical flow of FIG. 9 is shown as a series of discrete steps, the scope of embodiments is not so limited. Various embodiments may add, omit, rearrange, or modify one or more actions. For instance, the logical flow of FIG. 9 may also include implementing changes as changes arise. For instance, when a Medicaid law changes, one or more models may be changed, as needed or desired. Changes at the Medicaid level may be implemented at the Medicaid IT Architecture (MITA) Framework model level and flowed down to the industry solution level and the customer-specific level. Changes at a customer-specific level may be implemented at the customer-specific level, but in any event, may be recorded at higher levels in order to facilitate reuse of solutions or tracking of changes.

The above methods and systems have advantages. By using the methods described a more effective delivery process will prevail. Internal communications will improve by using blueprints, and all involved will be able to see how the MMIS components support the business processes. Cross state communication would be facilitated by a common set of blueprints. Differences between each state can be easily identified. Internal information is easy to find and share. External communications between the vendor and the customers is improved by using MITA to bridge the gaps in understanding.

By adopting the use of the blueprint, individuals can more easily understand the MMIS solution. Individuals can more easily understand the Medicaid Business Processes and how the MMIS is used in those processes. The Information Architecture provides a method to better understand the Medicaid Enterprise. Changes can be illustrated using the blueprints, enable individuals to better understand how industry changes impact the MMIS product, how changes to the MMIS product impact the State; and how State changes impact the MMIS product.

Adopting standards is as simple as calling Medicaid beneficiaries “members” instead of “client,” “recipient” or other state specific terms will increase reusability and clarity. Using MITA as the standard, customers can adopt the CMS standard rather than implementing a state or vendor-specific standard. This modeling approach will provide traceability as well from RFP requirements though testing and certification.

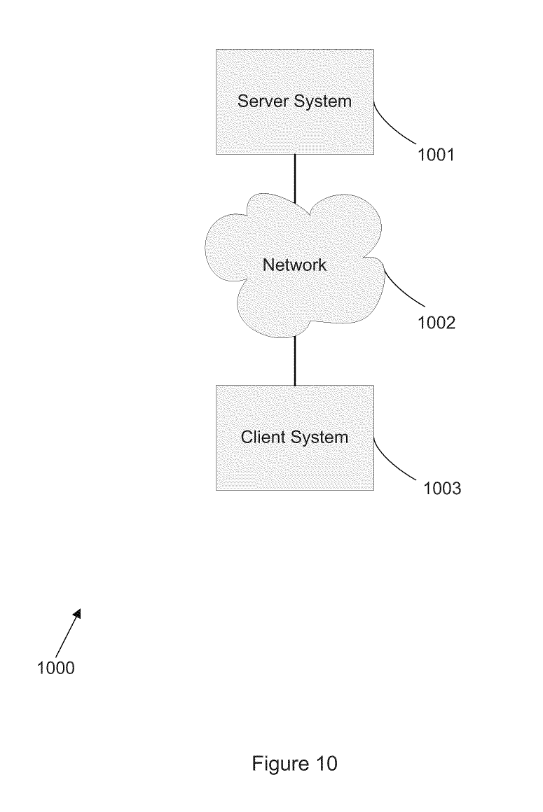

FIG. 10 is an illustration of an exemplary system 1000, adapted according to principles of the present disclosure, for implementing the solutions and processes described above. For instance, the exemplary system 1000 shows a possible environment on which industry models, management information system models, and customer-specific models may be created and maintained. Thus, an application creation software tool may be run on the system 1000 and used to create and maintain customer software solutions. Similarly, the system 1000 may be used by a customer to execute a software solution. Additionally, a computer system belonging to an entity that creates and delivers software solutions may communicate with a customer's computer system over a network, such as the network 1002, shown in FIG. 10.

The system 1000 includes a server system 1001 that is in communication with a client system 1003 over the network 1002. The system 1000 is exemplary, and it is understood that the scope of embodiments includes computer systems that have more or fewer computers than that shown in FIG. 10. Furthermore, while the examples given above are in the context of Medicaid standards, other embodiments may be adapted for use with any of a variety of other standards.

It is recognized that the above systems and methods operate using computer hardware and software in any of a variety of configurations. Such configurations can include computing devices, which generally include a processing device, one or more computer readable media, and a communication device. Other embodiments of a computing device are possible as well. For example, a computing device can include a user interface, an operating system, and one or more software applications. Several example computing devices include a personal computer (PC), a laptop computer, or a personal digital assistant (PDA). A computing device can also include one or more servers, one or more mass storage databases, and/or other resources.

A processing device is a device that processes a set of instructions. Several examples of a processing device include a microprocessor, a central processing unit, a microcontroller, a field programmable gate array, and others. Further, processing devices may be of any general variety such as reduced instruction set computing devices, complex instruction set computing devices, or specially designed processing devices such as an application-specific integrated circuit device.

Computer readable media includes volatile memory and non-volatile memory and can be implemented in any method or technology for the storage of information such as computer readable instructions, data structures, program modules, or other data. In certain embodiments, computer readable media is integrated as part of the processing device. In other embodiments, computer readable media is separate from or in addition to that of the processing device. Further, in general, computer readable media can be removable or non-removable. Several examples of computer readable media include, RAM, ROM, EEPROM and other flash memory technologies, CD-ROM, digital versatile disks (DVD) or other optical storage, magnetic cassettes, magnetic tape, magnetic disk storage or other magnetic storage devices, or any other medium that can be used to store desired information and that can be accessed by a computing device. In other embodiments, computer readable media can be configured as a mass storage database that can be used to store a structured collection of data accessible by a computing device.

A communications device establishes a data connection that allows a computing device to communicate with one or more other computing devices via any number of standard or specialized communication interfaces such as, for example, a universal serial bus (USB), 802.11a/b/g network, radio frequency, infrared, serial, or any other data connection. In general, the communication between one or more computing devices configured with one or more communication devices is accomplished via a network such as any of a number of wireless or hardwired WAN, LAN, SAN, Internet, or other packet-based or port-based communication networks.

The above specification, examples and data provide a complete description of the manufacture and use of the composition of the invention. Since many embodiments of the invention can be made without departing from the spirit and scope of the invention, the invention resides in the claims hereinafter appended.

1. A system for developing a repeatable customer-specific software solution model from an industry standard, the system comprising:
an industry module for creating a single industry standard model around an industry standard, the industry module including a Medicaid IT Architecture (MITA) Framework model with a blueprint that has descriptions of at least one business process that is typical to MITA;
a software module for creating a single industry software solution model from the industry standard model; and
a specific module for creating at least one customer-specific software solution model from the industry software solution model.

2. The system of claim 1 in which the system comprises a computing infrastructure running a sequence of computer implemented operations.

3. The system of claim 1 in which the software module includes a library of software components that perform a plurality of business processes.

4. The system of claim 1 in which the specific module comprises one or more state-specific blueprints.

5. The system of claim 1 in which the one or more state-specific blueprints maps one or more software components to a plurality of state-specific business processes.

6. The system of claim 1 in which the at least one customer-specific software solution model includes a software platform executable on at least one computer for managing Medicaid business processes.
